(19) United States
(12) Patent Application Publication
(10) Pub. No.: US 2026/0233349 A1
(43) Pub. Date: Aug. 13, 2026

(54) FULLY AUTOMATED PROCESS AND CELLS FOR CLAD WELDING CYLINDERS

(71) Applicant: Taylor-Winfield Technologies, Inc., Youngstown, OH (US)

(72) Inventors: Mike Bayer, Youngstown, OH (US); John Chelbus, Youngstown, OH (US); Tim Vesey, Youngstown, OH (US); Jeff Bell, Youngstown, OH (US); Jeremy Sterba, Youngstown, OH (US)

(73) Assignee: Taylor-Winfield Technologies, Inc., Youngstown, OH (US)

(21) Appl. No.: 19/535,349

(22) Filed: Feb. 10, 2026

Related U.S. Application Data
(60) Provisional application No. 63/756,461, filed on Feb. 10, 2025.

(51) Int. Cl. B23K 37/053; B23K 37/02; B23K 101/06; B25J 11/00

(52) U.S. Cl. CPC B23K 37/053; B23K 37/0258; B23K 2101/06; B25J 11/005

(57) ABSTRACT

A fully automated cell for clad welding cylinders has an entry conveyor at one end and an exit conveyor at a second end. A cylinder is moved into position into the cell using the entry conveyor. A robotic arm loads a cylinder onto a rotating fixture. The rotating fixture retains a first end of the cylinder; and a stationary fixture retaining a second end of the cylinder. A welding hood and a welding nozzle are aligned with the cylinder to create a weld clad onto the cylinder using a weld torch as the cylinder is rotated by the rotating fixture. A part ejector receives the cylinder and ejects the cylinder onto the exit conveyor.

### CLAIM OF PRIORITY

This application claims priority from Provisional Patent Application Serial No. 63/756,461, filed on February 10, 2025, the entirety of which is hereby incorporated by reference herein.

### BACKGROUND OF THE DISCLOSURE

This disclosure relates to weld cladding cylinder machines. More particularly, it relates to a fully automated system for weld cladding cylinders.

Existing partially automated MIG weld cladding cylinder machines only automate the welding process. Such automated machines would require that operators load cylinders, close safety gates, initiate automated welding sequences, open safety gates and unload weldment.

Other operator duties include tedious setup of the weld machine using manual gauges, intuitively adjusting the welding process to keep welding within its process limits, trimming the weld wire to the correct extension beyond the nozzle, and replacing the nozzle as well as diffusers and contact tips. In addition, operators would maintain the machine by cleaning debris and fouling caused by the weld process (i.e. weld spatter). The part fixture equipment and weld nozzles specifically would need to be cleaned from debris at regular intervals and as needed. The operator would then inspect the parts to ensure they were free from debris or continue to clean until debris free. Operators would spray the part fixtures with anti-spatter spray to minimize fouling. Lastly, the operator may need to remove stuck parts from the machine fixture if parts do not eject from the fixture after the automated welding sequence. This is an extremely time-intensive process to perform manually.

Thus, there exists a need for a fully automated process using cells for clad welding cylinders which overcomes the above mentioned difficulties and others while provided better overall results.

### SUMMARY OF THE DISCLOSURE

This disclosure relates to weld cladding cylinder machines. More particularly, it relates to a fully automated process using cells for cladding cylinders.

In accordance with one aspect of the disclosure, a fully automated cell for clad welding cylinders includes an entry conveyor at one end of the cell; a robotic arm for loading a cylinder onto a rotating fixture, wherein the rotating fixture retains a first end of the cylinder; a stationary fixture for retaining a second end of the cylinder; a welding hood and a welding nozzle/torch which are aligned with the cylinder; wherein the welding nozzle is lowered to create a weld clad onto the cylinder as it is rotated by the rotating fixture; and a part ejector which receives the cylinder and ejects the cylinder onto an exit conveyor at an opposite end of the cell.

In accordance with another aspect of the disclosure, the fully automates the process of weld cladding cylinders.

In accordance with another aspect of the disclosure, the system requires virtually no human interaction except to start and stop the machine, change jobs or to reload fresh new weld wire spool. The level of automation is quite extensive. The system can be supplied in a single bank, a two bank cell, a four bank cell, and an eight bank cell of cylinders.

In accordance with another aspect of the disclosure, there are an entry and exit conveyor which can interface with upstream and downstream operations of the cells. The entry conveyor feeds parts to each bank in a cell and the exit conveyor receives finished weldments from each bank in a cell. As parts travel down the entry conveyor, each bank will receive an incoming shell, suspend a shell if needed allowing the robot to pick it up and place it either the part fixture or bank queue.

In accordance with another aspect of the disclosure, a robotic arm loads a cylinder part into a rotating fixture, then the rotating fixture extends to push the part into the stationary fixture. Once the part is secured in place or “fixtured”, a weld fume hood descends to close proximity to a weld torch. The fixture rotates and the weld cladding process is initiated. The welding head traverses back and forth to create the weld clad in approximately one rotation of the cylinder. The weld fume hood then retracts. Then, the fixture retracts and the cylinder is released. The cylinder ejector then ejects the cylinder onto the exit conveyor.

In accordance with still another aspect of the disclosure, each bank has a safety fence surrounding the cell which has operator access including an operator gate and a weld nozzle replenish tray. Each bank has its own power panel for isolated shut down of the bank. In a multi bank cell configuration, one or more banks can be shut down and isolated while the other banks can continue to operate. This allows for high system reliability and uptime while still providing safe access for maintenance.

In accordance with another aspect of the disclosure, the system features a six axis robotic arm. A tool table used in conjunction with the robotic arm provides three different end effector options. The end effectors include: (i) grippers to load cylinders into the machine fixture; (ii) trimmers to trim the weld wire to the correct extension beyond the weld nozzle; and an (iii) multi-function cleaning tool.

In accordance with still another aspect of the disclosure, wire trimming and cleaning frequency can be inputted into an Operator Interface. The fixture is cleaned mechanically and with air jets using the multi function cleaning end effector. The same end effector applies an anti weld spatter spray to the part fixtures. The same multi-function cleaning tool torques and removes the weld nozzle where it is returned to the tool table. The tool table provides stations for weld nozzle mechanical cleaning, air jet, and inspection. If the nozzle is rejected by the automated camera inspection, it is placed in the reject tray. A new nozzle may be picked up from the clean weld nozzle tray and installed and torqued on by the same end effector.

In accordance with yet another aspect of the disclosure, if the welding process requires water cooling, the system provides a water tank, chiller and pump. Water cooling nozzles are installed at both the stationary and rotating fixtures. If the part is stuck in the fixture, the system automatically detects this condition. A sequence of steps is automatically taken including the part ejector cycling additional times and the robot grippers applying torque to the part.

In accordance with another aspect of the disclosure, an automated method of weld cladding cylinders, comprising: providing a fully automated cell for clad welding cylinders, comprising: providing an entry conveyor at one end of the cell for moving a cylinder into the cell for weld cladding; loading the cylinder onto a rotating fixture via a robotic arm; retaining a first end of the cylinder by the rotating fixture; retaining a second end of the cylinder by a stationary fixture; aligning a welding hood and weld nozzle with the cylinder; creating a weld clad onto the cylinder by the weld nozzle which traverses back and forth as the cylinder is rotated by the rotating fixture; and ejecting the cylinder onto an exit conveyor via a part ejector.

Still other aspects of the disclosure will become apparent upon a reading and understanding of the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front elevational view of an eight bank fully automated production cell in accordance with one aspect of the disclosure.

FIG. 2 is a perspective view of the eight bank cell of FIG. 1;

FIG. 3 is a perspective view of a four bank fully automated production cell in accordance with another aspect of the disclosure;

FIG. 4 is a perspective view of a fully automated production bank;

FIG. 5 is a perspective view of a cylinder fixtured and ready for welding; and

FIG. 6 is a perspective view of a robotic arm and tool table.

### DETAILED DESCRIPTION OF THE DISCLOSURE

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect purpose of the element or number modified by such term.

As used herein, the recitation of numerical ranges by endpoints includes all numbers subsumed within that range (e.g. 1 to 5 includes 1,1.5, 2, 2.75, 3, 3.6, 4 and 5 and the like). Similarly, where multiple ranges are set forth with respect to an item, it is intended that the ranges reflect the various combinations thereof (e.g. 1 to 5 or 2 to 3 also includes the ranges 1 to 3 and 2 to 5, and the like).

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated or process as “consisting of” and “consisting essentially of” the enumerated ingredients/steps, which allows the presence of only the named ingredients/steps, along with any impurities that might result therefrom, and excludes other ingredients/steps.

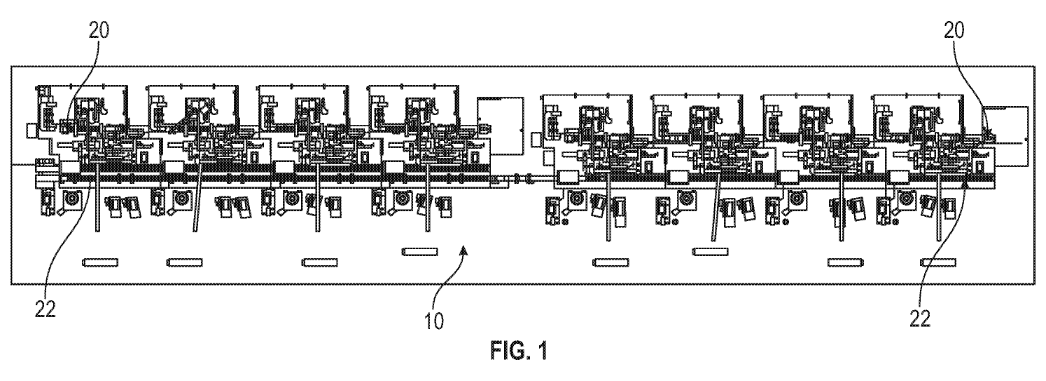

Referring now to FIGS. 1-6, a fully automated system which fully automates the process of weld cladding cylinders in accordance with a preferred embodiment of the disclosure is shown. The system requires virtually no human interaction except to start and stop the machine, change jobs or to reload fresh new weld wire spool.

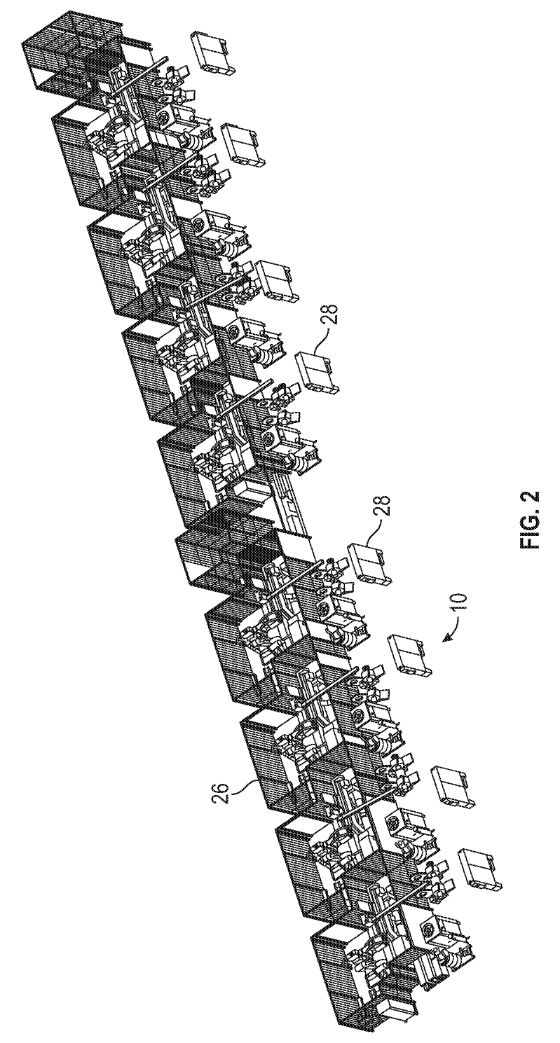

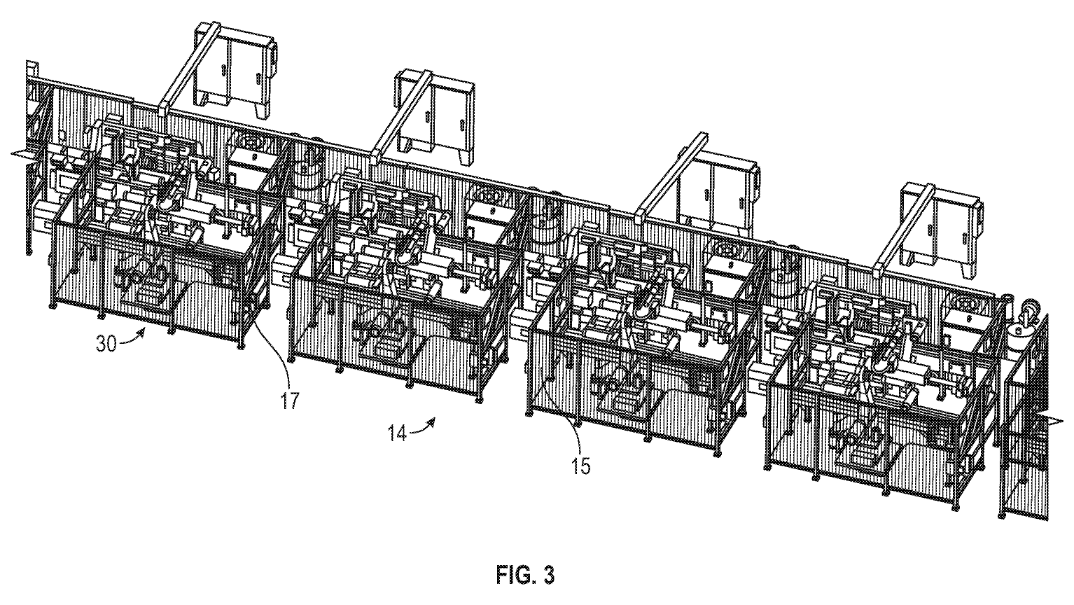

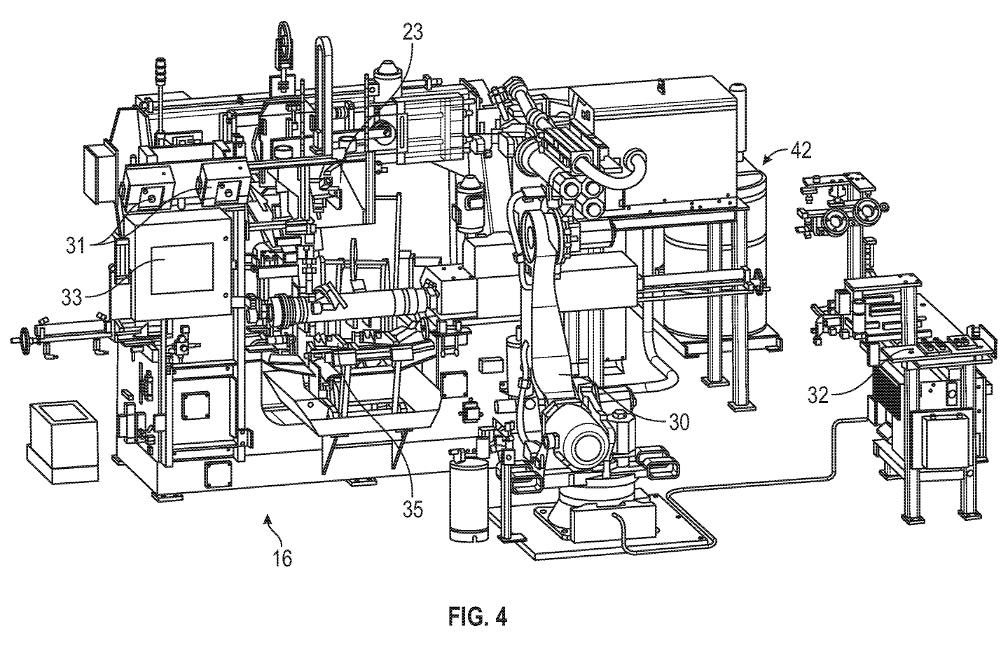

In particular, the system can be supplied in a single bank cell 16 (FIG. 4), two banks of cells (not shown), four banks of cells 14 (FIG. 3), and eight banks of cells 10 (FIGS. 1, 2). In all configurations, there is a entry conveyor 20 and exit conveyor 22 which can interface with upstream and downstream operations and are located at opposite ends of the system (see FIG. 1). One of the entry conveyors 20 feeds parts or cylinders to each bank in a cell while the exit conveyor 22 receives finished weldments (i.e. clad welded cylinders) from each bank in a cell. As parts travel down the entry conveyors 20, each bank will receive an incoming shell, suspend a shell if needed allowing a robotic arm 30 (FIG. 4) to pick it up and place it either the part fixture or bank queue.

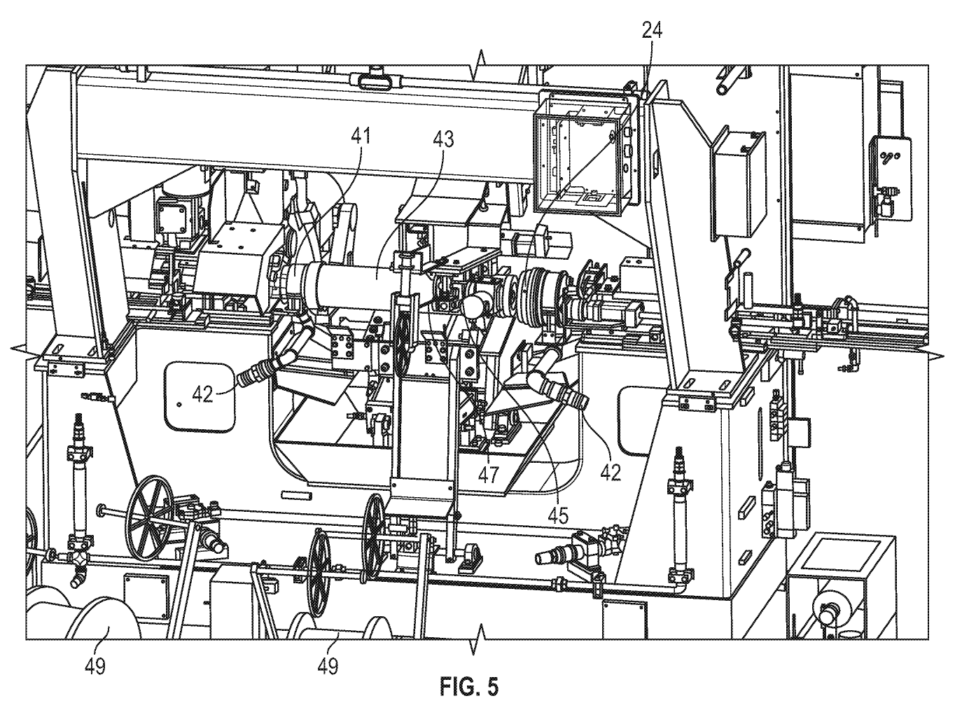

Once the robotic arm 30 loads a part or cylinder 43 (FIG. 5) into the rotating and extending fixture 41, fixture 41 extends to push the part into the stationary fixture 24 (see FIG. 5). Once the part i.e. cylinder 43 is secured or “fixtured,” using a weld controller 31, the weld fume hood 23 (FIG. 4) descends to close proximity to the weld nozzle 45 (FIG. 5). The fixture 41 rotates and the weld cladding process is thereby initiated using weld wire 47 from wire spools 49. The weld nozzle 45 traverses bank and forth and uses a torch to create the weld clad in approximately one rotation of the cylinder. The weld fume hood 23 then retracts. The fixture 41 retracts and the cylinder is thereby released. The part ejector 35 (FIG. 5) then ejects the cylinder onto the exit conveyor 22 (FIG. 1).

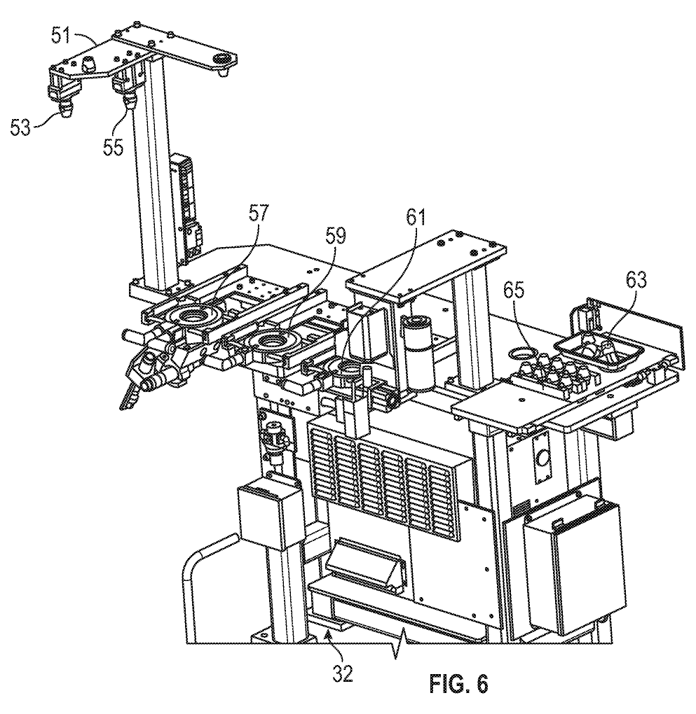

Referring now to FIG. 2, each bank has a safety fence 26 which surrounds each cell and allows operator access including a operator gate 15 (FIG. 3) and weld nozzle replenish tray 65 (FIG. 6). Each bank has its own power panel 28 for isolated shut down (FIG. 2). In a multi bank cell configuration, one or more banks can be shut down and isolated while the other banks continue to operate. This allows high system reliability and uptime while still providing safe access for maintenance.

The system features a six-axis robotic arm 30 as shown in FIG. 4. A tool table 32 (FIG. 6) is used in conjunction with the robotic arm and provides three different end effector options for use in conjunction with the robotic arm. The end effectors are as follows (from left to right in FIG. 6): 1) a multi-function cleaning end effector 57; and 2) a gripper end effector 59 with grippers to load cylinders into the machine fixture; 3) wire trimmers 61 to trim the weld wire to the correct extension beyond the weld nozzle.

Wire trimming and cleaning frequency can be inputted into the Operator Interface 33 (FIG. 4). The fixtures 41, 24 are cleaned mechanically and with air jets using the multi function cleaning end effector 57. The same end effector applies an anti weld spatter spray to the part fixtures. The same multi-function cleaning tool torques and removes the weld nozzle where it is returned to the tool table 32. The tool table 32 provides stations for weld nozzle mechanical cleaning, air jet, and inspection (FIG. 6). If the nozzle is rejected by the automated camera inspection, it is placed in the nozzle reject tray 63 (FIG. 6). A new nozzle may be picked up from the clean weld nozzle tray 65 and installed and torqued on by the same end effector.

To produce good parts, a group of setup parameters (wire angles, tip distance, oscillation width, concentricity, etc.) must fall within specifications. An integrated vision system and precision laser sensor provides real time remote video as well as actual real time weld height. In addition, the weld controller monitors critical process parameters in real time (current, voltage, wire feed rate, rotation position/speed, etc). The measurements verifies that the welder is and will produce good parts and that, in turn, confirm the setup of the weld process parameters. These measurements and remote video are displayed on the operator panel.

If the welding process requires water cooling, the system comes with a water tank, chiller and pump 42 (FIGS. 4, 5). Water cooling nozzles are installed at both the stationary 24 and rotating fixtures 41. If the part is stuck in one of the fixtures, the system automatically detects this condition. A sequence of steps is automatically taken including the part ejector cycling additional times and the robot grippers 59 applying torque to the part.

Referring to FIG. 3, the cell can further include an operator gate 15 and a weld cup replenish tray 17.

Referring to FIG. 6, the system can also include a weld cup air cleaner 51, and a weld cup mechanical cleaner 53, and weld cup inspectors 55. The multi-function cleaning end effector 57 may be used for other applications as well.

The disclosure has been disclosed with respect to a preferred embodiment. Obviously, modifications and alterations could occur to others upon a reading and understanding of the above detailed specification. It is intended to include all such modifications and alterations insofar as they come within the scope of the specification and the appended claims as the equivalents thereof.

What is claimed is:

1. A fully automated cell for clad welding cylinders, comprising:
an entry conveyor at one end of the cell for moving an associated cylinder into the cell;
a robotic arm for loading the associated cylinder onto a rotating fixture;
wherein said rotating fixture retains a first end of the associated cylinder to be clad welded;
a stationary fixture for retaining a second opposite end of the associated cylinder;
a welding hood and a welding nozzle which are aligned with the associated cylinder;
wherein said welding hood and nozzle are lowered to create a weld clad onto the associated cylinder as it is rotated by the rotating fixture; and,
a part ejector which receives the associated cylinder and ejects the associated cylinder onto an exit conveyor at an opposite end of the cell .

2. The fully automated cell of claim 1, further comprising a robotic arm table having a multi-function cleaning end effector.

3. The fully automated cell of claim 2, further comprising a gripper end effector comprising grippers to load associated cylinders into the cell.

4. The fully automated cell of claim 2, further comprising wire trimmers to trim welding wire for use with said welding nozzle.

5. The fully automated cell of claim 1, further comprising an operator interface to input wire trimming and cleaning.

6. The fully automated cell of claim 1, further comprising a water cooling system for cooling the stationary and rotating fixtures.

7. The fully automated cell of claim 1, further comprising a spool containing welding wire to provide to the welding nozzle.

8. The fully automated cell of claim 1, further comprising a safety fence which surrounds the cell.

9. The fully automated cell of claim 1, further comprising a power panel for powering and shutting down the cell.

10. A fully automated system for clad welding cylinders, comprising:
two banks of fully automated cells as recited in claim 1.

11. A fully automated system for clad welding cylinders, comprising:
four banks of fully automated cells as recited in claim 1.

12. A fully automated system for clad welding cylinders, comprising:
eight banks of fully automated cells as recited in claim 1.

13. An automated method of cladding cylinders, comprising:
providing a fully automated cell for clad welding cylinders;
providing an entry conveyor at one end of the cell for moving a cylinder into the cell for weld cladding;
loading the cylinder onto a rotating fixture via a robotic arm;
retaining a first end of the cylinder by the rotating fixture;
retaining a second end of the cylinder by a stationary fixture;
aligning a welding hood and nozzle with the cylinder;
creating a weld clad onto the cylinder by the welded nozzle which traverses back and forth as the cylinder is rotated by the rotating fixture; and
ejecting the cylinder onto an exit conveyor via a part ejector.
